(19) United States
(12) Patent Application Publication
(10) Pub. No.: US 2025/0157711 A1
(43) Pub. Date: May 15, 2025

(54) SOLENOID VALVE AND COIL ASSEMBLY OF ELECTRONIC BRAKE SYSTEM

(71) Applicant: HL MANDO CORPORATION, Gyeonggi-do (KR)

(72) Inventors: Heechul JUNG, Gyeonggi-do (KR); Kwanseek KIM, Gyeonggi-do (KR)

(21) Appl. No.: 18/744,507

(22) Filed: Jun. 14, 2024

(30) Foreign Application Priority Data
Nov. 14, 2023 (KR) 10-2023-0157521

(51) Int. Cl. H01F 7/08; B60T 13/68; H01F 7/16

(52) U.S. Cl. CPC H01F 7/081; B60T 13/686; H01F 7/16

(57) ABSTRACT

A coil assembly of a solenoid valve press-fitted into a bore of a hydraulic block provided with an inlet flow path and an outlet flow path includes: a bobbin, wherein a through hole is defined by an inner surface of the bobbin, the bobbin including a winding portion provided with a coil wound along an outer surface of the bobbin; the coil wound on the winding portion and configured to generate a magnetic force according to a provided electrical signal; a case coupled to the bobbin and surrounding an outer surface of the bobbin; and a first heat transfer material filled between the case and a recessed portion formed at an entrance side of the bore into which the solenoid valve is press-fitted and which is deformed.

### CROSS-REFERENCE TO RELATED APPLICATION(S)

This application is based on and claims priority under 35 U.S.C. § 119 to Korean Patent Application No. 10-2023-0157521, filed on Nov. 14, 2023, in the Korean Intellectual Property Office, the disclosure of which is incorporated by reference herein in its entirety.

### BACKGROUND

### 1. Field

The disclosure relates to a solenoid valve and a coil assembly of an electronic brake system, and more particularly, to a solenoid valve installed in a hydraulic block of an electronic brake system of a vehicle to control a flow of a brake fluid, and a coil assembly of the solenoid valve.

### 2. Description of the Related Art

Brake systems for brake are essential to vehicles, and various types of brake systems are proposed for the safety of drivers and passengers.

Existing brake systems have generally used a method of supplying, when a driver steps on the brake pedal, hydraulic pressure for brake to the wheel cylinder through a booster mechanically connected to the brake pedal. However, the market's needs for embodying various braking functions by delicately responding to the operational environments of vehicles are increasing. Accordingly, lately, an electronic brake system that receives, when a driver steps on the brake pedal, the driver's intention to brake as an electrical signal from a pedal displacement sensor that has detected a displacement of the brake pedal and operates a hydraulic supply based on the electrical signal to supply hydraulic pressure required for brake to the wheel cylinder is becoming increasingly widespread.

The electronic brake system generates, in a normal mode, a driver's control operating the brake pedal as an electrical signal and electrically operates and controls the hydraulic supply based on the electrical signal to generate hydraulic pressure required for brake and transfer the hydraulic pressure to the wheel cylinder.

The flow of the hydraulic pressure generated by the hydraulic supply is controlled by a plurality of solenoid valves provided in a plurality of hydraulic flow paths, and transferred to the wheel cylinder.

Each solenoid valve is on/off controlled by a magnetic field generated in a coil. While the coil operates, heat is generated. When such continuously generated heat is not stably discharged to the outside, components made of plastic may be damaged or wires, etc. may be deformed by heat to become disconnected or short-circuited. Accordingly, a component for stably discharging heat generated in the coil to the outside is needed.

### SUMMARY

It is an aspect of the disclosure to provide a solenoid valve and a coil assembly of an electronic brake system capable of stably transferring heat generated in a coil to the outside.

Additional aspects of the disclosure will be set forth in part in the description which follows and, in part, will be obvious from the description, or may be learned by practice of the disclosure.

According to an aspect of the disclosure, a coil assembly of a solenoid valve press-fitted into a bore of a hydraulic block provided with an inlet flow path and an outlet flow path may include: a bobbin, wherein a through hole is defined by an inner surface of the bobbin, the bobbin including a winding portion provided with a coil wound along an outer surface of the bobbin; the coil wound on the winding portion and configured to generate a magnetic force according to a provided electrical signal; a case coupled to the bobbin and surrounding an outer surface of the bobbin; and a first heat transfer material filled between the case and a recessed portion formed at an entrance side of the bore into which the solenoid valve is press-fitted and which is deformed.

The first heat transfer material may include a heat conductive resin.

The bobbin may include a metal material.

The bobbin may include aluminum or an aluminum alloy.

The coil assembly may further include a second heat transfer material provided between an outer surface of the coil and an inner surface of the case.

The second heat transfer material may include a heat conductive resin and may be filled in such a way as to be in contact with the outer surface of the coil and the inner surface of the case.

The second heat transfer material may be provided as a gap pad being in contact with the outer surface of the coil and the inner surface of the case.

According to an aspect of the disclosure, a solenoid valve press-fitted into a bore of a hydraulic block provided with an inlet flow path and an outlet flow path may include: a magnet core inserted in the bore, wherein a through hole is formed by penetrating the magnet core in a longitudinal direction; a sleeve coupled to an outer surface of the magnet core; an armature installed in the sleeve; a valve seat fixed in the through hole and including an orifice; a plunger positioned in the through hole and configured to move up and down by an operation of the armature to open or close the orifice; a return spring configured to press the plunger toward the armature; and a coil assembly configured to provide a magnetic force to the armature, wherein the coil assembly may include: a bobbin, wherein a through hole is defined by an inner surface of the bobbin, the bobbin including a winding portion provided with a coil wound along an outer surface of the bobbin; the coil wound on the winding portion and configured to generate a magnetic force according to a provided electrical signal; a case coupled to the bobbin and surrounding an outer surface of the bobbin; and a first heat transfer material filled between the case and a recessed portion formed at an entrance side of the bore into which the solenoid valve is press-fitted and which is deformed.

The first heat transfer material may include a heat conductive resin.

The bobbin may include a metal material.

The bobbin may include aluminum or an aluminum alloy.

The coil assembly may further include a second heat transfer material provided between an outer surface of the coil and an inner surface of the case.

The second heat transfer material may include a heat conductive resin and be filled in such a way as to be in contact with the outer surface of the coil and the inner surface of the case.

The second heat transfer material may be provided as a gap pad being in contact with the outer surface of the coil and the inner surface of the case.

According to an aspect of the disclosure, an electronic brake system may include: a hydraulic block, wherein a bore provided with an inlet flow path and an outlet flow path is formed in the hydraulic block; a solenoid valve press-fitted into the bore; and an electronic control unit configured to control opening/closing of the solenoid valve, wherein the solenoid valve may include: a magnet core inserted in the bore, wherein a through hole is formed by penetrating the magnet core in a longitudinal direction; a sleeve coupled to an outer surface of the magnet core; an armature installed in the sleeve; a valve seat fixed in the through hole and including an orifice; a plunger positioned in the through hole and configured to move up and down by an operation of the armature to open or close the orifice; a return spring configured to press the plunger toward the armature; and a coil assembly configured to provide a magnetic force to the armature according to an electrical signal provided from the electronic control unit, wherein the coil assembly may include: a bobbin, wherein a through hole is defined by an inner surface of the bobbin, the bobbin including a winding portion provided with a coil wound along an outer surface of the bobbin; the coil wound on the winding portion and configured to generate a magnetic force according to a provided electrical signal; a case coupled to the bobbin and surrounding an outer surface of the bobbin; and a first heat transfer material filled between the case and a recessed portion formed at an entrance side of the bore into which the solenoid valve is press-fitted and which is deformed.

The first heat transfer material may include a heat conductive resin.

The bobbin may include a metal material.

The bobbin may include aluminum or an aluminum alloy.

The coil assembly may further include a second heat transfer material provided between an outer surface of the coil and an inner surface of the case.

The second heat transfer material may include a heat conductive resin and be filled in such a way as to be in contact with the outer surface of the coil and the inner surface of the case.

The second heat transfer material may be provided as a gap pad being in contact with the outer surface of the coil and the inner surface of the case.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view schematically showing a hydraulic assembly for an electronic brake system according to an embodiment;

FIG. 2 is a cross-sectional view schematically showing an internal configuration of a hydraulic assembly for an electronic brake system according to an embodiment;

FIG. 3 is a cross-sectional view showing a configuration of a solenoid valve of an electronic brake system according to an embodiment;

FIG. 4 is a cross-sectional view showing a solenoid valve and a coil assembly of an electronic brake system according to an embodiment; and

FIG. 5 is a cross-sectional view showing a heat dissipation path of a coil assembly of an electronic brake system according to an embodiment.

### DETAILED DESCRIPTION

Hereinafter, embodiments of the disclosure will be described in detail with reference to the accompanying drawings. The following embodiments are provided to transfer the technical concepts of the disclosure to one of ordinary skill in the technical art to which the disclosure belongs. However, the disclosure is not limited to these embodiments, and may be embodied in another form. In the drawings, parts that are irrelevant to the descriptions may be not shown in order to clarify the disclosure, and also, for easy understanding, the sizes of components are more or less exaggeratedly shown.

Hereinafter, an operation principle and embodiments of the disclosure will be described with reference to the accompanying drawings.

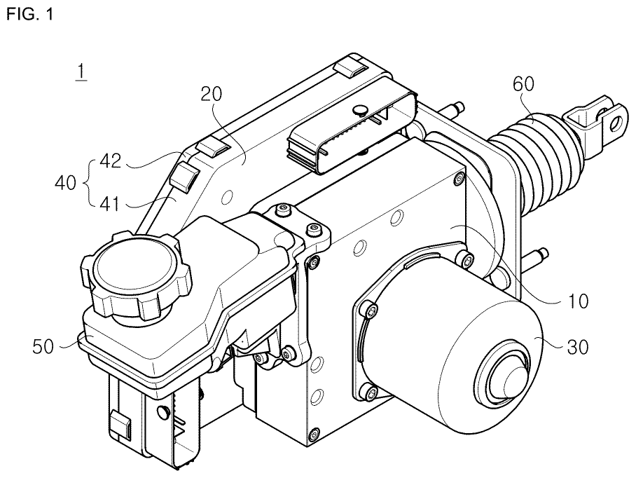

FIG. 1 is a perspective view schematically showing a hydraulic assembly for an electronic brake system according to an embodiment.

An electronic brake system 1, which is controlled by an electronic control unit 20, may perform braking by controlling a hydraulic supply according to a displacement of a brake pedal to generate hydraulic pressure and controlling a hydraulic control unit including a plurality of flow paths and a plurality of solenoid valves 200 to transfer the generated hydraulic pressure to a plurality of wheel cylinders provided in wheels of a vehicle.

The electronic brake system 1 may be provided as a package such as a hydraulic assembly configured by coupling the solenoid valves 200 for controlling hydraulic pressure, the hydraulic supply, etc. to a hydraulic block 10 in which a plurality of bores and flow paths are formed and coupling the hydraulic block 10 to a housing 40 in which the electronic control unit 20 for controlling the solenoid valves 200 and the hydraulic supply is provided. In the hydraulic block 10, a master cylinder 60 connected to the brake pedal, a reservoir 50 in which a pressing medium is stored, etc. may be additionally provided.

In FIG. 1, a hydraulic assembly constituting the electronic brake system 1 according to an embodiment is shown. Referring to FIG. 1, the hydraulic assembly of the electronic brake system 1 may include the hydraulic block 10 in which the plurality of solenoid valves 200, the flow paths, and the hydraulic supply are installed to adjust braking hydraulic pressure to be supplied to the plurality of wheel cylinders, a motor 30 installed on a front surface of the hydraulic block 10 to provide power to the hydraulic supply, a reservoir 50 installed on the hydraulic block 10 to store a brake fluid, the master cylinder 60 installed in the hydraulic block 10 and connected to the brake pedal to generate hydraulic pressure, and the electronic control unit 20 installed on a rear surface of the hydraulic block 10 to control the motor 30 and the plurality of solenoid valves 200.

The electronic control unit 20 may be accommodated in the housing 40, wherein the hydraulic block 10 is installed on the front surface of the housing 40. The housing 40 may include a housing body 41 which forms an accommodating space therein and of which one side opens, and a cover 42 coupled to the open side of the housing body 41.

The hydraulic block 10 may have a cuboid body made of metal such as aluminum. In each surface of the hydraulic block 10, a bore (not shown) for accommodating a plurality of valves, sensors, etc. may be provided.

According to an embodiment, the master cylinder 60 may be mounted on a side of the hydraulic block 10. The master cylinder 60 may be an apparatus that transfers a brake fluid according to a driver's intention to brake, and may include an input rod connected to the brake pedal, and a master piston connected to the input rod and configured to move back and forth inside a master chamber to press the brake fluid. Also, the master cylinder 60 may further include a pedal simulator provided in the master chamber to provide the driver with pedal feeling.

While the driver steps on the brake pedal, the input rod connected to the brake pedal may move, and accordingly, the master cylinder 60 may generate hydraulic pressure. Accordingly, the master cylinder 60 may be installed on a side of the hydraulic block 10 and connected to the brake pedal provided in a vehicle body.

At a side of the hydraulic block 10, a master cylinder accommodating bore accommodating the master cylinder 60 and a pedal sensor accommodating bore accommodating a pedal displacement sensor (not shown) may be formed.

In a front side of the hydraulic block 10, a hydraulic supply accommodating bore may be formed to accommodate the hydraulic supply for supplying hydraulic pressure. The hydraulic supply for providing pressure of a brake fluid may be installed in the hydraulic supply accommodating bore. The hydraulic supply may be configured with a pump, and the pump may include a power converter for converting a rotational motion of the motor 30 into a linear motion, and a hydraulic piston connected to the power converter and configured to move back and forth to generate hydraulic pressure.

The motor 30 may be installed at a location corresponding to the hydraulic supply accommodating bore in the front side of the hydraulic block 10. The motor 30 may provide power to the hydraulic supply such that the hydraulic supply generates hydraulic pressure, and may be controlled by receiving an electrical signal from the electronic control unit 20 through a motor connector, etc.

In the hydraulic block 10, a reservoir connecting port communicating with the reservoir 50 that stores the brake fluid may be provided. The reservoir connecting port may be provided as a plurality of holes that communicate with the reservoir 50 and are spaced from each other. The reservoir 50 may be installed at a location corresponding to the reservoir connecting port and supply the brake fluid through a flow path communicating with the reservoir connecting port.

In the hydraulic block 10, a plurality of wheel cylinder connecting ports that communicate with the wheel cylinders may be provided. Hydraulic pressure generated in the hydraulic supply may be transferred to the wheel cylinders through the wheel cylinder connecting ports to perform braking.

In a rear side of the hydraulic block 10, a plurality of bores 11 in which the plurality of solenoid valves 200 are inserted may be provided. In each bore 11, an inlet flow path 13 and an outlet flow path 14 may be provided, and each solenoid valve 200 may be positioned between the inlet flow path 13 and the outlet flow path 14 to open or close the inlet flow path 13 and the outlet flow path 14 and thereby control a flow of the brake fluid.

The electronic control unit 20 may be mounted on the rear side of the hydraulic block 10 and control a plurality of coil assemblies 100 of the plurality of solenoid valves 200 inserted in the bores 11 to control opening/closing of the solenoid valves 200.

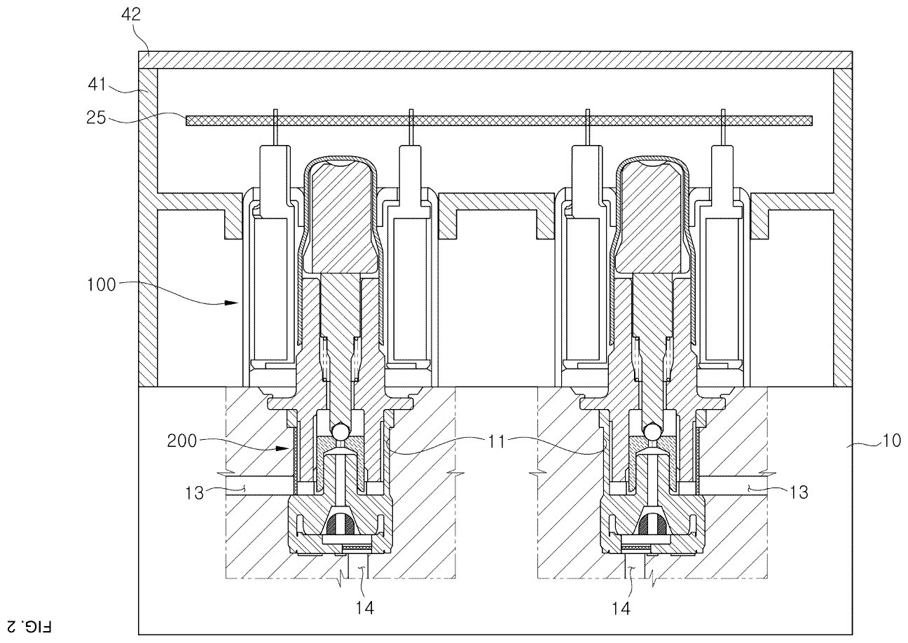

FIG. 2 is a cross-sectional view schematically showing an internal configuration of a hydraulic assembly for an electronic brake system according to an embodiment.

In FIG. 2, an arrangement of the electronic control unit 20 and the coil assemblies 100 of the solenoid valves 200 is shown.

As shown in FIG. 2, the electronic brake system 1 may include the hydraulic block 10 in which the bore 11 provided with the inlet flow path 13 and the outlet flow path 14 is formed, the solenoid valve 200 press-fitted into the bore 11, and the electronic control unit 20 that controls opening/closing of the solenoid valve 200.

The electronic control unit 20 may be accommodated inside the housing 40. The housing 40 may include the housing body 41 which forms an accommodating space therein and of which one side opens, and the cover 42 coupled to the open side of the housing body 41. In the accommodating space of the housing body 41, a circuit board 25 constituting the electronic control unit 20 may be accommodated.

The solenoid valve 200 may include a sleeve 220 in which an armature 230 is installed in such a way as to move back and forth to open or close an orifice 241 therein, and a coil assembly 100 which is in a shape of a cylinder and which the sleeve penetrates and is coupled to, wherein the coil assembly 100 may provide a magnetic force to the armature 230 according to an electrical signal provided from the electronic control unit 20. A lower portion of the solenoid valve 200 may be press-fitted into the hydraulic block 10, and the coil assembly 100 may be installed in the housing body 41 of the electronic control unit 20. The coil assembly 100 may be electrically connected to the circuit board 25 constituting the electronic control unit 20 to receive an electrical signal from the electronic control unit 20.

Hereinafter, a configuration of the solenoid valve 200 will be described in more detail.

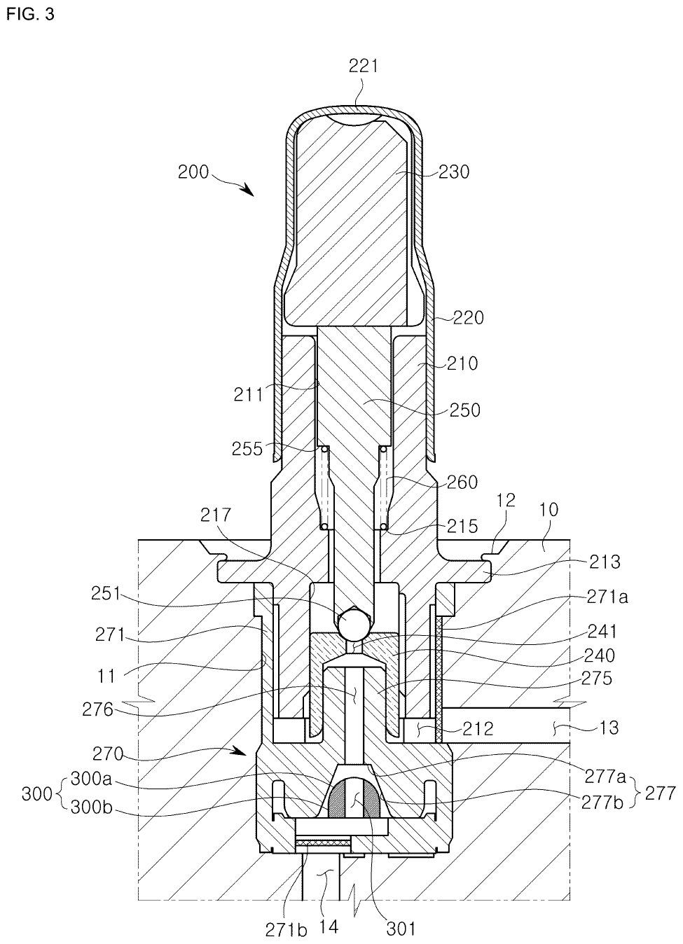

FIG. 3 is a cross-sectional view showing a configuration of a solenoid valve of an electronic brake system according to an embodiment.

In FIG. 3, an embodiment in which the solenoid valve 200 of the electronic brake system 1 is a normal open solenoid valve in which, while the coil assembly 100 provides no magnetic force to the armature 230, the orifice 241 opens is shown. However, the disclosure is not limited to this, and the solenoid valve 200 of the electronic brake system may be a normal close solenoid valve in which, while the coil assembly 100 provides no magnetic force to the armature 230, the orifice 241 is closed.

Referring to FIG. 3, the solenoid valve 200 of the electronic brake system 1 according to an embodiment may include a magnet core 210 which is inserted in the bore 11 of the hydraulic block 10 and in which a through hole 211 is formed by penetrating the magnet core 210 in a longitudinal direction, the sleeve 220 coupled to an outer surface of the magnet core 210, the armature 230 installed in the sleeve 220, a valve seat 240 fixed in the through hole 211 and including the orifice 241, a plunger 250 positioned in the through hole 211 and moving up and down by an operation of the armature 230 to open or close the orifice 241, and a return spring 260 pressing the plunger 250 toward the armature 230.

Also, the solenoid valve 200 may further include a filter member 270 coupled to the magnet core 210 and accommodated in the bore 11.

The magnet core 210 may be in a shape of a cylinder including the through hole 211 penetrating the magnet core 210 in the longitudinal direction. Inside a lower area of the through hole 211 of the magnet core 210, a valve seat installing portion 217 into which the valve seat 240 forming the orifice 241 is press-fitted and fixed may be formed. Also, on an upper inner circumferential surface of the through hole 211 of the magnet core 210, a spring support protrusion 215 protruding to support a lower end of the return spring 260 may be provided.

The valve seat 240 may open at the lower end and be in a shape of a hollow cylinder. The valve seat 240 may be press-fitted into a lower opening of the valve seat installing portion 217.

The orifice 241 penetrating an upper center of the valve seat 240 may be selectively opened or closed by an opening/closing portion 251 of the plunger 250.

The filter member 270 may enter the bore 11 of the hydraulic block 10 in a state of being coupled to the magnet core 210.

The filter member 270 may include a circumferential portion 271 surrounding a lower outer surface of the magnet core 210, and a boss portion 275 positioned at an inner center of the magnet core 210, inserted inside the magnet core 210 through the lower opening of the valve seat 240, and integrated into the circumferential portion 271.

The circumferential portion 271 may accommodate a lower portion of the magnet core 210 therein, and an outer surface of the circumferential portion 271 may be supported on an inner surface of the bore 11 of the hydraulic block 10.

In a center of the boss portion 275, a connection flow path 276 for communicating the orifice 241 with the outlet flow path 14 may be formed by penetrating the boss portion 275, and at a lower end of the connection flow path 276, a plunger valve seat portion 277 having a greater diameter than an upper portion of the connection flow path 276 may be formed.

The plunger valve seat portion 277 may include a horizontal surface 277a extending horizontally at the lower end of the connection flow path 276, and an inclined surface 277b inclined downward such that a diameter of the inclined surface 277b gradually increases downward from an edge of the horizontal surface 277a.

In the circumferential portion 271 of the filter member 270, a first filter 271a for filtering oil entering a radial flow path 212 formed between the filter member 270 and a lower end of the magnet core 210 through the inlet flow path 13 of the hydraulic block 10 may be provided, and at a lower end of the filter member 270, a second filter 271b for filtering out foreign materials of oil discharging toward the outlet flow path 14 may be provided. The first filter 271a and the second filter 271b may be provided at locations facing the inlet flow path 13 and the outlet flow path 14, respectively.

In an inside space of the plunger valve seat portion 277, a plunger valve 300 may be positioned in such a way as to be movable up and down by pressure of supplied oil.

The plunger valve 300 may be formed in a cross-sectional arch shape including a sealing portion 300a that is in a shape of a hemisphere and provided at the upper end to contact the plunger valve seat portion 277 when rising by pressure of supplied oil, and a cylinder portion 300b positioned below the sealing portion 300a. In a center of the plunger valve 300, a vertical hole 301 penetrating the plunger valve 300 in a vertical and longitudinal direction may be formed, and the vertical hole 301 may communicate the connection flow path 276 with the outlet flow path 14.

The plunger 250 may move back and forth in an up-down direction inside the through hole 211 above the valve seat 240. The plunger 250 may include the opening/closing portion 251 to open or close the orifice 241 at the lower end. Also, the plunger 250 may be, while no power is applied to the coil assembly 100, pressed toward the armature 230 by the return spring 260 to open the orifice 241. On an outer surface of an upper portion of the plunger 250, a stepped portion 255 stepped inward to support an end of the return spring 260 may be provided on which the return spring 260 is stably installed to provide an elastic force to the plunger 250. Because the step-type spring support protrusion 215 for supporting another end of the return spring 260 is provided in the through hole 211 of the magnet core 210, as described above, the lower end of the return spring 190 may be supported on the spring support protrusion 215 and the upper end of the return spring 190 may be supported on the stepped portion 165 of the outer surface of the plunger 160.

The sleeve 220 may be in a shape of a cylinder, and coupled to the outer surface of the magnet core 210.

The sleeve 220 may include a dome-shaped closing portion 221 provided at the upper portion to close an upper portion of the magnet core 210.

The armature 230 may be positioned in an upper inside of the sleeve 220, that is, inside the dome-shaped closing portion 221 to be movable up and down.

When power is applied to the coil assembly 100, the armature 230 may move to press the plunger 250, thereby closing the orifice 241.

The magnet core 210 may include a flange portion 213 fixed to an entrance side of the bore 11 of the hydraulic block 10.

Upon installing of the solenoid valve 200 in the hydraulic block 10, the magnet core 210, the filter member 270, the valve seat 240, the plunger 250, the armature 230, the sleeve 220, etc. may be first assembled outside the hydraulic block 10, and then the filter member 270 and the magnet core 310 may be inserted into the bore 11 of the hydraulic block 10.

In this state, the entrance side of the bore 11 of the hydraulic block 10 may be deformed. Accordingly, a deformed portion of the entrance side of the bore 11 may be deformed to cover the flange portion 213 of the magnet core 210 and fix the magnet core 210, thereby completing installation of the solenoid valve 200.

According to another embodiment, a lower end of the sleeve 220 instead of the magnet core 210 may be bent and provided as a flange portion, and the deformed portion of the entrance side of the bore 11 may be deformed to cover the flange portion of the sleeve 220 and fix the sleeve 220, thereby completing installation of the solenoid valve 200.

As such, the entrance side of the bore 11 of the hydraulic block 10 may be deformed, and accordingly, a recessed portion 12 for fixing the flange portion 213 may be provided. Upon installation of the solenoid valve 200, the flange portion 213 may be inserted inside the recessed portion 12 and then, an upper side of the recessed portion 12 may be deformed to cover the flange portion 213.

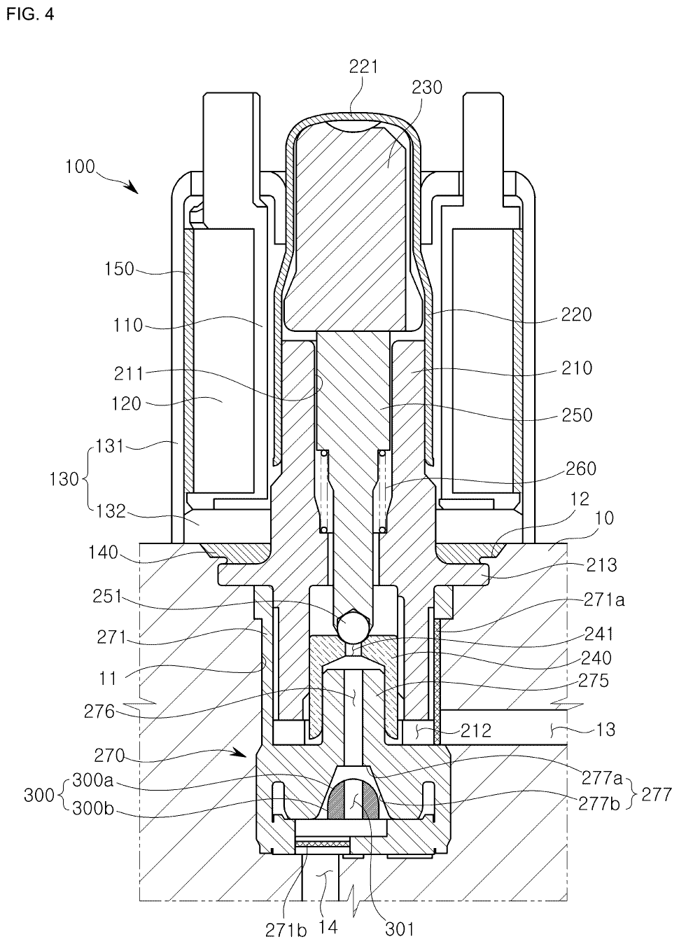

FIG. 4 is a cross-sectional view showing a solenoid valve and a coil assembly of an electronic brake system according to an embodiment.

The solenoid valve 200 may further include the coil assembly 100 that provides a magnetic force to the armature 230 according to an electrical signal provided from the electronic control unit 20. As described above, the coil assembly 100 may be in a shape of a cylinder to provide a magnetic force to the armature 230, and the sleeve 220 of the solenoid valve 200 may be coupled to the coil assembly 100 by penetrating the coil assembly 100.

Referring to FIG. 4, the coil assembly 100 according to an embodiment may include a bobbin 110 having a through hole defined by the inner surface and a winding portion provided with a coil 120 wound along the outer surface, the coil 120 wound on the winding portion to generate a magnetic force according to a provided electrical signal, a case 130 coupled to the bobbin 110 and surrounding the outer surface of the bobbin 110, a first heat transfer material 140 filled between the recessed portion 12 and the case 130, the recessed portion 12 positioned at the entrance side of the bore 11 of the hydraulic block 10 into which the solenoid valve 200 is press-fitted and which is deformed, and a second heat transfer material 150 provided between an outer surface of the coil 120 and an inner surface of the case 130.

The bobbin 110 may further include an upper frame provided at an upper side of the winding portion to limit an upper winding range of the coil 120, and a lower frame provided at a lower side of the winding portion to limit a lower winding range of the coil 120.

The bobbin 110 may include the through hole which is formed along the inner surface and in which the sleeve 220 and the magnetic core 210 are inserted.

The coil 120 wound on the winding portion of the bobbin 110 may be electrically connected to the electronic control unit 20, and generate a magnetic force according to a control of the electronic control unit 20 to operate the armature 230 of the solenoid valve 200.

The bobbin 110 on which the coil 120 is wound may be accommodated inside the case 130 surrounding the outer surface of the bobbin 110. The case 130 may include an outer case 131 surrounding the outer surface of the bobbin 110 and being in a shape of a cylinder of which a lower side opens, and a cap 132 covering the open side of the outer case 131.

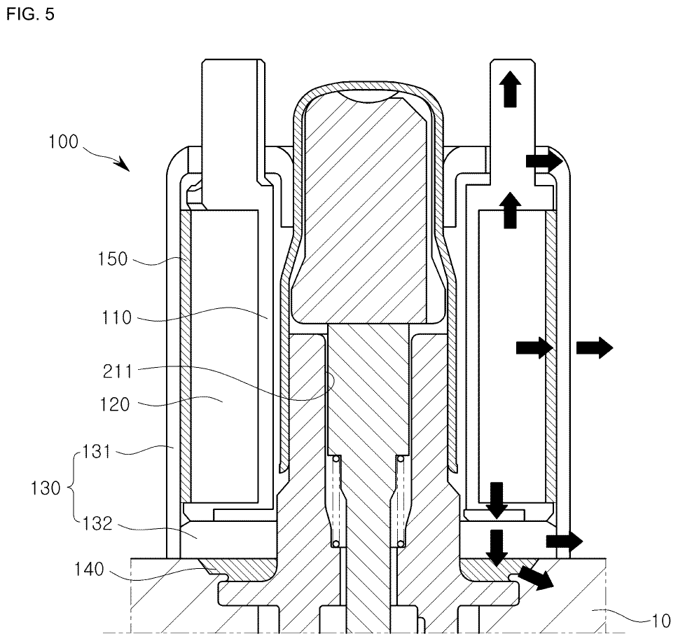

FIG. 5 is a cross-sectional view showing a heat dissipation path of a coil assembly of an electronic brake system according to an embodiment.

While power is supplied to the coil 120 of the coil assembly 100 as shown in FIG. 4 and thus a magnetic force is generated, heat may be generated in the coil 120 by current flowing on the coil 120. Accordingly, it may be necessary to prevent the coil 120 from being damaged by overheating by discharging heat generated in the coil 120 to outside.

The coil 120 may be wound on the winding portion of the bobbin 110, and spaced from the case 130 by the upper frame and the lower frame of the bobbin 110.

The coil assembly 100 according to an embodiment may include a component for discharging heat to the outside through the case 130 exposed to the outside and having a large surface area.

According to an embodiment, the coil 120 may be made of a material having high heat conductivity. By making a wire forming the coil 120 with a material having high heat conductivity and excellent heat dissipation, heat generated in the coil 120 may be stably discharged to the outside through the wire.

Also, according to an embodiment, the bobbin 110 may include a metal material. Generally, the bobbin 110 of the coil assembly 100 is made of a plastic material. However, the bobbin 110 according to an embodiment may increase heat conductivity by including a metal material to transfer heat through the bobbin 110. Preferably, the bobbin 110 may include metal having high heat conductivity, for example, aluminum or an aluminum alloy.

Because the coil 120 is in direct contact with the bobbin 110, heat generated in the coil 120 may be transferred through the bobbin 110 including a metal material having high heat conductivity and the case 130 coupled to the bobbin 110, and easily discharged to the outside.

Also, according to an embodiment, the second heat transfer material 150 may be provided between the outer surface of the coil 120 and the inner surface of the case 130 to discharge heat generated in the coil 120 to the outside.

As shown in the drawings, the outer surface of the coil 120 may be spaced a preset distance from the inner surface of the case 130 to prevent the coil 120 from being damaged due to contact with the case 130 that is hard.

According to an embodiment, because the second heat transfer material 150 is provided between the outer surface of the coil 120 and the inner surface of the case 130, heat generated in the coil 120 may be transferred to the case 130 and easily discharged to the outside.

Because the second heat transfer material 150 is made of a material having high heat conductivity, the second heat transfer material 150 may stably transfer heat from the coil 120 to the case 130.

According to an embodiment, the second heat transfer material 150 may include a heat conductive resin and be filled in such a way as to be in contact with the outer surface of the coil 120 and the inner surface of the case 130.

Upon assembling of the coil assembly 100, the coil 120 may be wound on the bobbin 110, the bobbin 110 on which the coil 120 is wound may be inserted into the inside of the case 130, and then, a liquid heat conductive resin may be filled between the outer surface of the bobbin 110 and the inner surface of the case 130, thereby achieving heat transfer through the heat conductive resin between the coil 120 and the case 130.

According to another embodiment, the second heat transfer material 150 may be provided as a gap pad that is in contact with the outer surface of the coil 120 and the inner surface of the case 130. The second heat transfer material 150 may be provided as a gap pad having high heat conductivity and made of a soft material to prevent the coil 120 from being damaged while stably transferring heat generated in the coil 120 to the case 130 because the second heat transfer material 150 is in contact with the coil 120 and the case 130.

Also, according to an embodiment, the first heat transfer material 140 filled between the case 130 and the recessed portion 12 positioned at the entrance side of the bore 11 of the hydraulic block 10 may be provided to discharge heat generated in the coil 120 to the outside.

As described above, heat generated in the coil 120 may be transferred to the case 130 through the bobbin 110, the second heat transfer material 150, etc. and thus discharged to the outside. Meanwhile, because the hydraulic block 10 of the electronic brake system 1 is made of metal having high heat conductivity such as aluminum, heat transferred from the case 130 to the hydraulic block 10 may be more stably discharged to the outside.

However, as described above, the recessed portion 12 may be provided at the entrance side of the bore 11 in which the solenoid valve 200 is inserted. Although the case 130 of the coil assembly 100, having a flat outer surface, partially contacts the hydraulic block 10, as shown in FIG. 5, a contact area between the case 130 and the hydraulic block 10 may be reduced by a space formed by the recessed portion 12.

According to an embodiment, the first heat transfer material 140 filled between the recessed portion 12 and the case 130 may stably transfer heat from the case 130 to the hydraulic block 10.

In an embodiment, the first heat transfer material 140 may include a heat conductive resin. After the solenoid valve 200 is press-fitted into the bore 11 of the hydraulic block 10, the first heat transfer material 140 made of a heat conductive resin may be filled in the recessed portion 12 positioned at the entrance side of the bore 11 and then, the coil assembly 100 may be coupled.

That is, in the coil assembly 100 according to an embodiment, heat generated in the coil 120 may be transferred to the case 130 through the bobbin 110 and the second heat transfer material 150, and the heat transferred to the case 130 may be discharged to the outside or transferred to the hydraulic block 10 through the first heat transfer material 140 and then discharged to the outside.

In this way, the solenoid valve 200 and the coil assembly 100 of the electronic brake system 1 according to an embodiment may easily discharge heat generated in the coil 120 to the outside. Accordingly, components may be prevented from being deformed and damaged by heat generated in the coil 120.

The solenoid valve and the coil assembly of the electronic brake system according to an embodiment may stably transfer heat generated in the coil to the outside.

The solenoid valve and the coil assembly of the electronic brake system according to an embodiment may prevent components from being damaged by heat generated in the coil.

What is claimed is:

1. A coil assembly of a solenoid valve disposed in a bore of a hydraulic block having inlet flow and outlet flow paths, the coil assembly comprising:
a bobbin having a through hole defined by an inner surface of the bobbin, the bobbin including a winding portion around which a coil is wound;
the coil wound around the winding portion of the bobbin to generate a magnetic force according to an electrical signal;
a case, wherein at least a part of the bobbin is disposed inside the case; and
a first heat transfer material disposed between a recessed portion formed at an end of the bore of the hydraulic block and the case in which at least a part of the bobbin is disposed.

2. The coil assembly of claim 1, wherein the first heat transfer material disposed between the recessed portion of the hydraulic block and the case includes a heat conductive resin.

3. The coil assembly of claim 1, wherein the bobbin has a metal material.

4. The coil assembly of claim 3, wherein the metal material of the bobbin includes aluminum or an aluminum alloy.

5. The coil assembly of claim 1, further comprising a second heat transfer material disposed between the coil and an inner surface of the case.

6. The coil assembly of claim 5, wherein the second heat transfer material includes a heat conductive resin and contacts the coil and the inner surface of the case.

7. The coil assembly of claim 5, wherein the second heat transfer material is provided as a gap pad contacting the coil and the inner surface of the case.

8. A solenoid valve disposed in a bore of a hydraulic block having an inlet flow and outlet flow paths, the solenoid valve comprising:
a magnet core disposed in the bore of the hydraulic block and having a through hole in the magnet core;
a sleeve coupled to an outer surface of the magnet core;
an armature disposed in the sleeve;
a valve seat fixed in the through hole of the magnet core and including an orifice;
a plunger movably positioned in the through hole of the magnet core to open or close the orifice of the valve seat;
a return spring configured to press the plunger toward the armature; and
a coil assembly configured to provide a magnetic force to the armature, wherein the coil assembly comprises:
a bobbin having a through hole defined by an inner surface of the bobbin, the bobbin including a winding portion around which a coil is wound;
the coil wound around the winding portion of the bobbin to generate a magnetic force according to an electrical signal;
a case, wherein at least a part of the bobbin is disposed inside the case; and
a first heat transfer material disposed between a recessed portion formed at an end of the bore of the hydraulic block and the case in which at least a part of the bobbin is disposed.

9. The solenoid valve of claim 8, wherein the first heat transfer material disposed between the recessed portion of the hydraulic block and the case includes a heat conductive resin.

10. The solenoid valve of claim 8, wherein the bobbin has a metal material.

11. The solenoid valve of claim 10, wherein the metal material of the bobbin includes aluminum or an aluminum alloy.

12. The solenoid valve of claim 8, wherein the coil assembly further comprises a second heat transfer material disposed between the coil and an inner surface of the case.

13. The solenoid valve of claim 12, wherein the second heat transfer material includes a heat conductive resin and contacts the coil and the inner surface of the case.

14. An electronic brake system comprising:
a hydraulic block in which a bore provided with inlet flow and outlet flow paths are formed;
a solenoid valve disposed in the bore; and
an electronic controller configured to control to open or close the solenoid valve,
wherein the solenoid valve comprises:
a magnet core disposed in the bore of the hydraulic block and having a through hole in the magnet core;
a sleeve coupled to an outer surface of the magnet core;
an armature disposed in the sleeve;
a valve seat fixed in the through hole of the magnet core and including an orifice;
a plunger movably positioned in the through hole of the magnet core to open or close the orifice of the valve seat;
a return spring configured to press the plunger toward the armature; and
a coil assembly configured to provide a magnetic force to the armature according to an electrical signal provided from the electronic controller,
wherein the coil assembly comprises:
a bobbin having a through hole defined by an inner surface of the bobbin, the bobbin including a winding portion around which a coil is wound;
the coil wound around the winding portion of the bobbin to generate a magnetic force according to an electrical signal;
a case, wherein at least a part of the bobbin is disposed inside the case; and
a first heat transfer material disposed between a recessed portion formed at an end of the bore of the hydraulic block and the case in which at least a part of the bobbin is disposed.

15. The electronic brake system of claim 14, wherein the first heat transfer material disposed between the recessed portion of the hydraulic block and the case includes a heat conductive resin.

16. The electronic brake system of claim 14, wherein the bobbin has a metal material.

17. The electronic brake system of claim 16, wherein the metal material of the bobbin includes aluminum or an aluminum alloy.

18. The electronic brake system of claim 14, wherein the coil assembly further comprises a second heat transfer material disposed between the coil and an inner surface of the case.

19. The electronic brake system of claim 18, wherein the second heat transfer material includes a heat conductive resin and contacts the coil and the inner surface of the case.
